(19) United States
(12) Patent Application Publication
(10) Pub. No.: US 2018/0354166 A1
(43) Pub. Date: Dec. 13, 2018

(54) CYLINDRICAL MOLD WITH INNER VARIABLE VOLUME

(71) Applicant: Covestro Deutschland AG, Leverkusen (DE)

(72) Inventors: Carlos Garcia, Xochimilco (MX); Efren Martinez, Ecatepec (MX); Salvador Mejia, Benito Juarez (MX)

(21) Appl. No.: 15/996,881

(22) Filed: Jun. 4, 2018

(30) Foreign Application Priority Data
Jun. 8, 2017 (MX) MX/A/2017/007488

(51) Int. Cl. B29C 44/58; B29C 44/02

(52) U.S. Cl. CPC B29C 44/58; B29K 2075/00; B29C 44/02

(57) ABSTRACT

Present invention refers to a cylindrical mold with interchangeable volume wherein the inner volume of the mold can be modified by substituting the circumferential wall of said mold, re-usable and with the possibility of being able to add inserts into the mentioned walls which represent a cavity intended for either electric and/or gas type water heaters, through which the effectiveness of the development of polyurethane systems for this final application is increased.

### OBJECT OF THE INVENTION

Present invention refers to a cylindrical mold with inner variable volume that may be used in the design of water heater applications obtaining representative pieces of polyurethane foam or another material with similar properties, specifically, such as thermal insulator. The invention also relates to a method of making foams using the cylindrical mold.

### BACKGROUND

In the state of the art, cylindrical molds for polyurethane or another material with similar properties are known, however, said molds tend to be monolithic and have a highly robust construction, such that, if it were to be necessary to modify the inner volume of the mold, then a new mold would need to be manufactured.

Water heaters are often insulated by enclosing a hollow core with a foam insulation, such as polyurethane foam insulation. The diameter of the hollow core can vary, depending on the size of the water heater. In evaluating and testing foam formulations for use in water heater applications, it can be expensive and cumbersome to insulate actual water heaters of varying sizes. Therefore, it is desired to have a convenient and inexpensive way to test and evaluate water heater foam formulations that is able to account for water heater of different diameters.

Taking into account the above problem, present invention has been developed, wherein a cylindrical mold has an inner volume that can be modified by substituting a circumferential wall of said mold and in which the circumferential wall can be easily removed to remove and test a foam that is formed in the mold.

### BRIEF DESCRIPTION OF THE INVENTION

Present invention refers to a cylindrical mold with inner variable volume which comprises an upper lid; a lower lid; at least a first and a second interchangeable circumferential walls, in such a way that one of said first and second circumferential walls is set between said upper and lower lids; a hollow core set in a concentric fashion to said at least a first and a second interchangeable circumferential walls; at least a closure for at least a first and a second interchangeable circumferential walls; and at least one fastening mechanism for fastening the lids which maintain the mold assembled.

### BRIEF DESCRIPTION OF THE FIGURES

The illustrative embodiment may be described referencing the accompanying figures, which refer to:

FIG. 1 shows an upper back perspective view of the mold of present invention;

FIG. 2 shows a lower back perspective view of the mold of present invention;

FIG. 3 shows a lateral left view of the mold of present invention;

FIG. 4 shows a front view of the mold of present invention;

FIG. 5 shows an exploded view of the mold of present invention;

FIG. 6 shows an upper view of the upper lid of the mold of present invention;

FIG. 7 shows an upper view of the lower lid of the mold of present invention;

FIG. 8 shows a frontal view of the hollow core of the mold of present invention;

FIGS. 9 and 10 show back views of first and second half cane sections of the first circumferential walls of the mold of present invention;

FIGS. 11 and 12 show back views of first and second half cane sections of the second circumferential walls of the mold of present invention;

FIG. 13 shows a detailed view of section A from FIG. 1;

FIG. 14 shows a view of the pivoting lever of the mold of present invention.

### DETAILED DESCRIPTION OF THE INVENTION

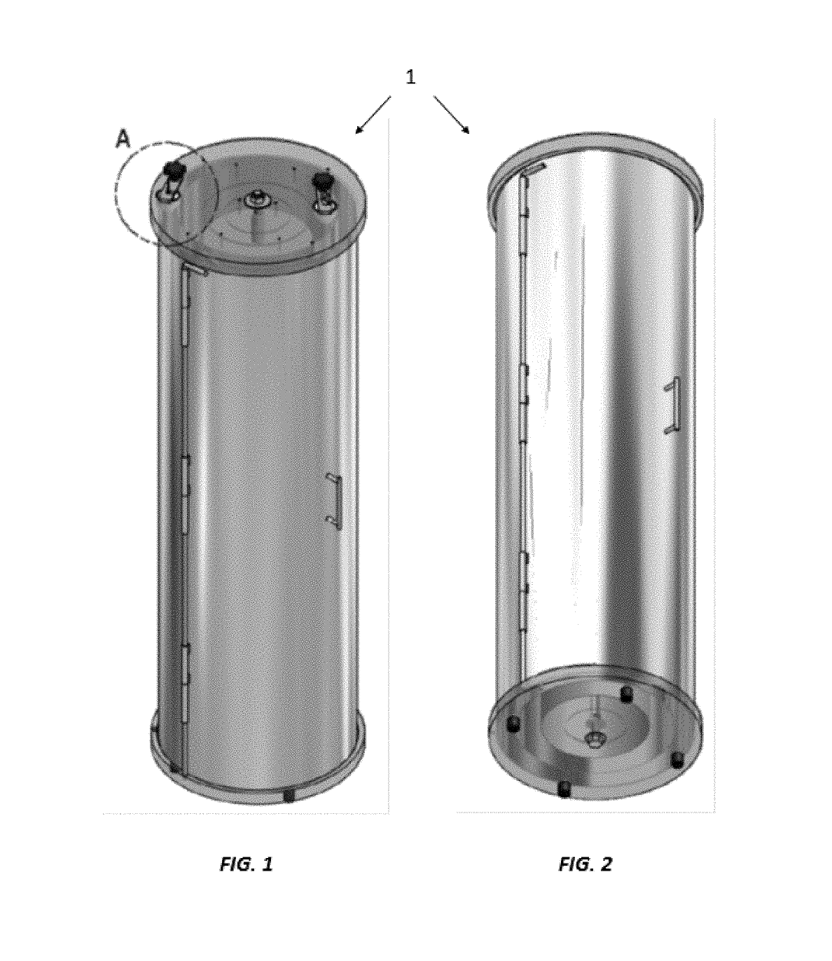

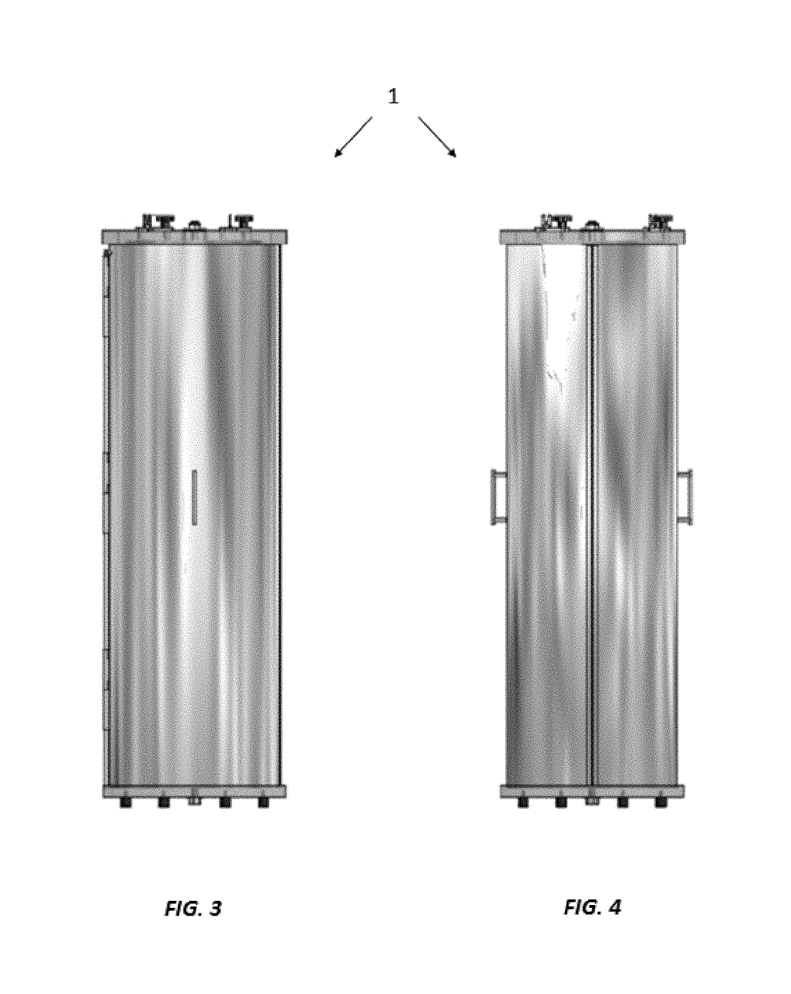

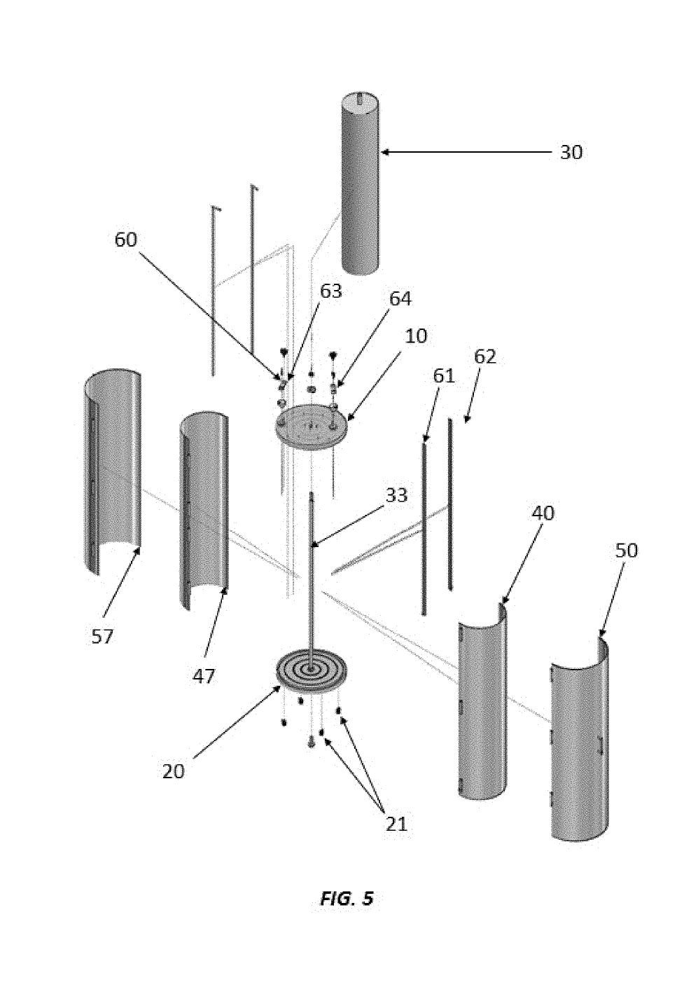

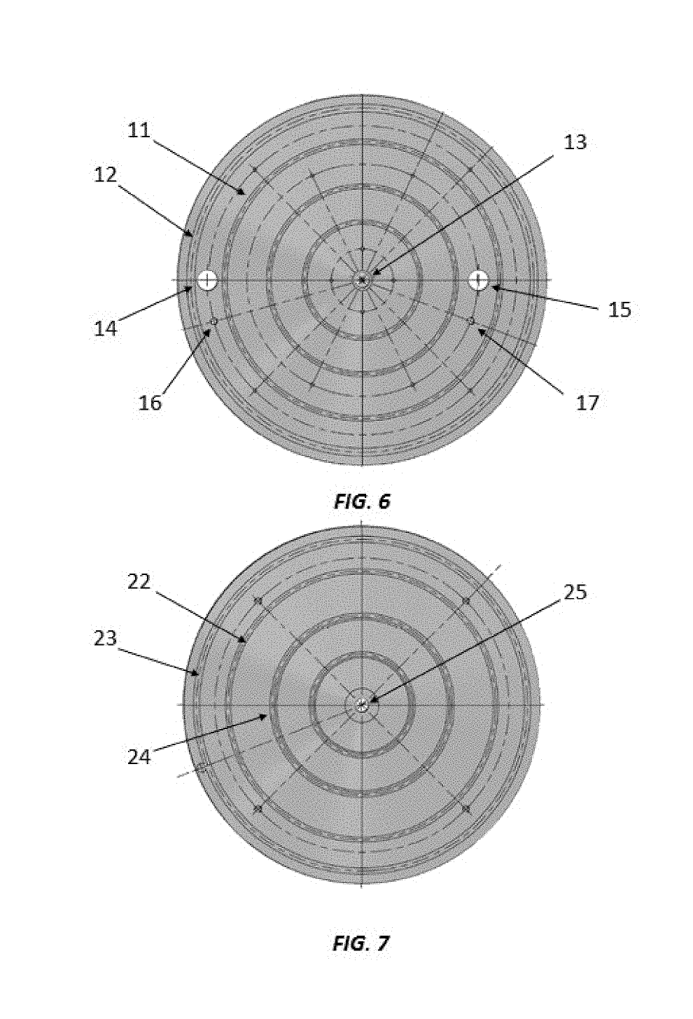

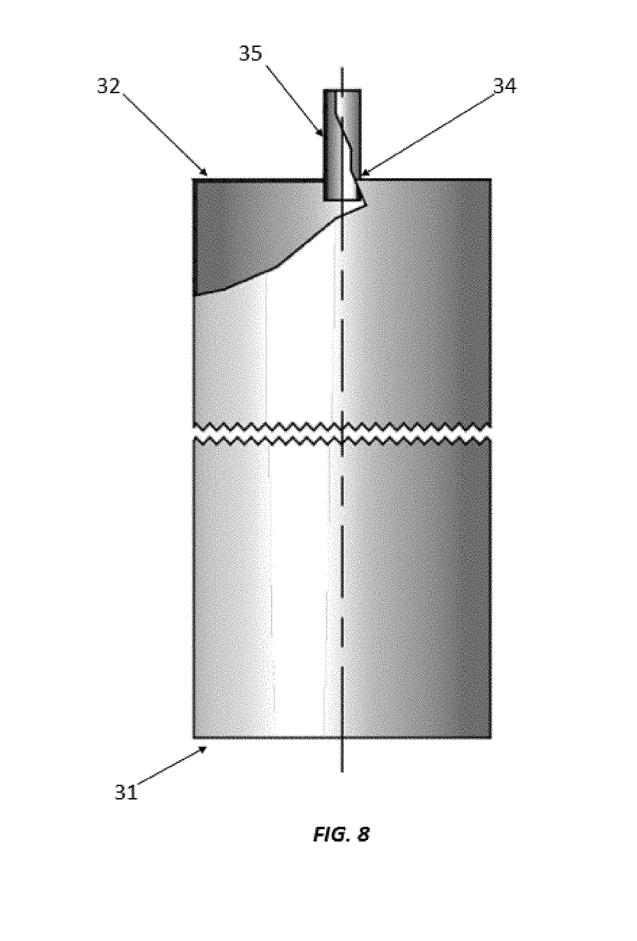

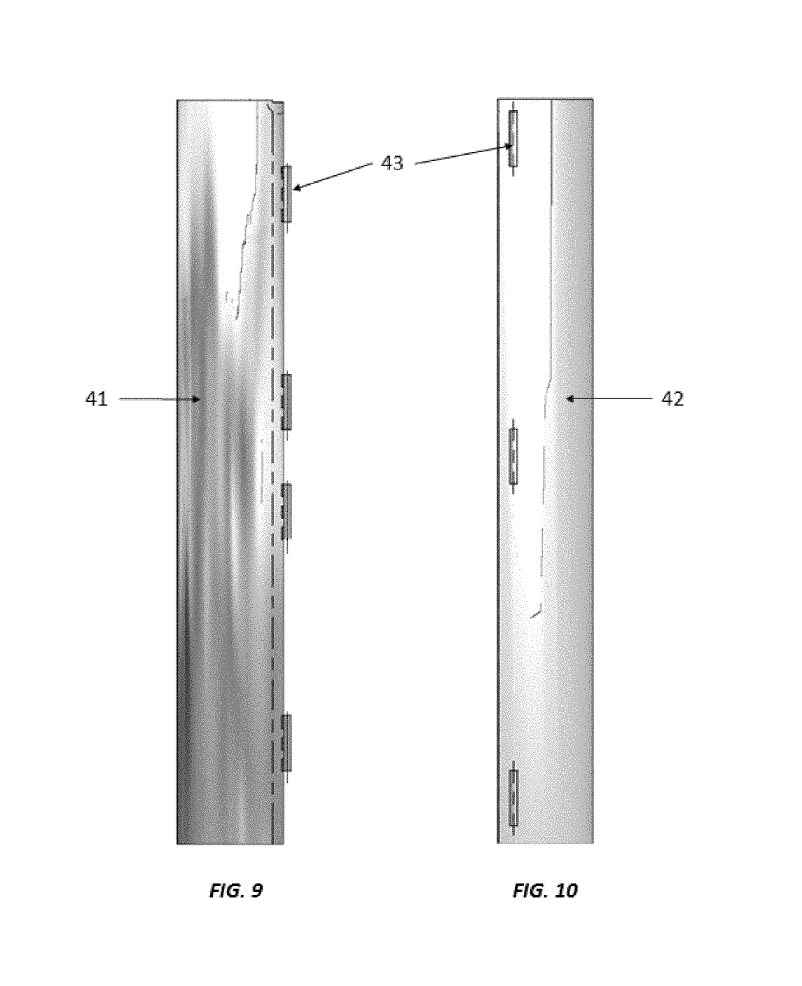

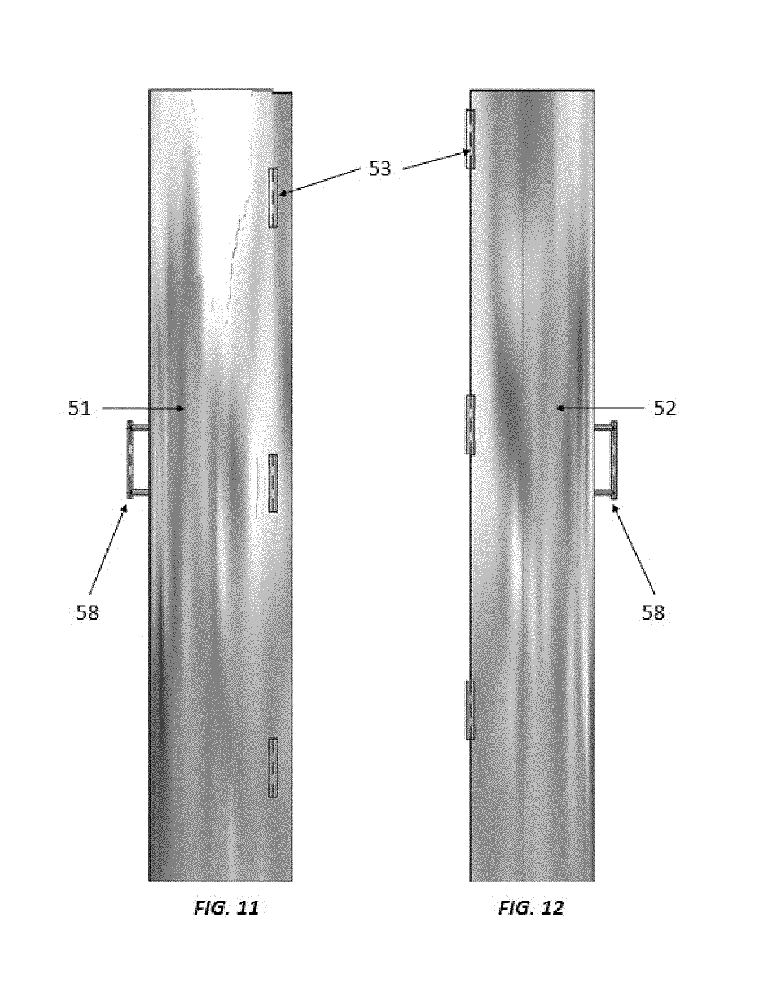

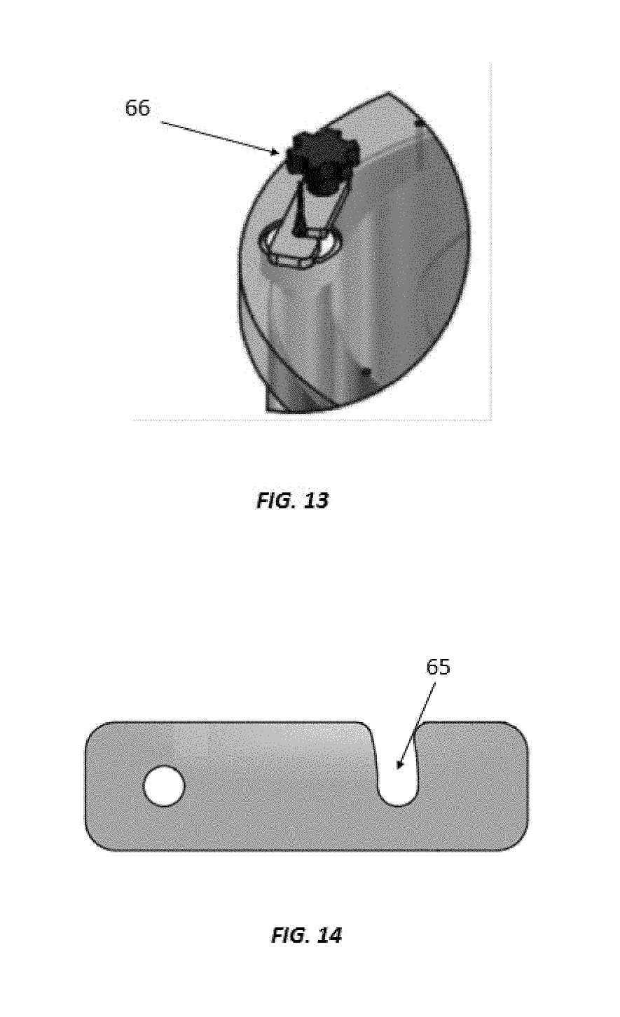

The description of present invention will be undertaken according to the embodiment shown in FIGS. 1 through 14 in an indistinct manner.

The cylindrical mold with interchangeable inner volume (1) of present invention presents on its upper end an upper lid (10), said upper lid (10) presents an upper surface and a lower surface, on said lower surface, at least a first circumferential groove (11) and a second circumferential groove (12) are found, wherein the radius of the second circumferential groove (12) is greater than the radius of the first circumferential groove (11), wherein the second circumferential groove (12) is found near the outer border of said upper lid (10).

Similarly, it presents a through orifice (13) which is set at the center of said upper lid (10) and concentric with said first (11) and second (12) circumferential grooves; additionally it presents a first (14) and a second (15) upper sites for fastening the rods, as well as a first (16) and a second (17) sites for fastening the pivoting lever, said first (14) and second (15) upper sites for fastening the rods, comprise through orifices set in the near vicinity of the first (11) and second (12) circumferential grooves, without exceeding the length of the radius of said first (11) and second (12) circumferential grooves.

The first (16) and second (17) sites for fastening the pivoting level comprise through orifices, set near said first (14) and second (15) upper rod fastening sites.

The upper lid (10) presents an orifice for the polyurethane foam injection and a plurality of vents (which are not shown), which can be free or obstructed depending on the purpose of the design.

The cylindrical mold with interchangeable inner volume (1) of the present invention presents on its lower end a lower lid (20), said lower lid (20) presents an upper surface and a lower surface, on said lower surface a plurality of support legs (21) are found which are fastened in coil or rivet manner, said plurality of support legs comprise at least three legs, preferably four legs, said plurality of support (21) legs being spaced in an equidistant manner. These legs may contain screws with coiled string to be able to change the inclination of the mold and cause different patterns for the polyurethane injection.

On the upper surface of said lower lid at least a first circumferential groove (22), a second circumferential groove (23) and a third circumferential groove (24) are found, wherein the radius of the second circumferential groove (23) is greater than the radius of the first circumferential groove (22), while the radius of the third circumferential groove (24) is lesser than the radius of the first circumferential groove (22); wherein the second circumferential groove (23) is found near the outer border of said lower lid (20).

Similarly, it presents a through orifice (25) which is set at the center of said lower lid (20) and concentric with said first (22), second (23) and third (24) circumferential grooves; additionally it presents a first and a second lower sites for fastening the rods (not shown), said first and second lower sites for fastening the rods, comprise coiled orifices set in the near vicinity of the first (22) and second (23) circumferential grooves.

Set between said upper lid (10) and lower lid (20) a hollow core (30) is found, said hollow core comprises a cylindrical body with a lower end which is open (31), which is inserted into the third circumferential groove (24) of the lower lid (2), and an upper end which is partially closed (32), said partially closed upper end (32) presents a cavity (34) from which a sleeve (35) is projected, from which a coiled rod (33) protrudes, which itself passes through the passing orifice (25) set in the center of the lower lid (20), and passes through the passing orifice (13) set at the center of said upper lid (10) and is fastened by means of screws (not shown).

In a similar manner, set between said upper lid (10) and lower lid (20), is one of a first interchangeable circumferential wall (40) and a second (50) interchangeable circumferential wall.

Said first circumferential wall (40) and second circumferential wall (50) are found divided in a first half cane section (41, 51) and a second half cane section (42, 52), joined by means of a hinge mechanism (43, 53); said first half cane section (41, 51) presents a brow (47, 57) which is overlapped with the second half cane section (42, 52) when said sections are closed.

The second circumferential wall (50) presents a radius which is greater than the first circumferential wall (40), in such a way that the first circumferential wall (40) is inserted into the first circumferential grooves (11 and 12) of the upper lid (10) and the lower lid (20), while the second circumferential wall (50) is inserted into the second circumferential grooves (12 and 23) of the upper lid (10) and the lower lid (20).

In a similar manner, the second circumferential wall (50) presents a pair of handles (58) which are diametrically opposite.

Additionally, said first circumferential wall (40) and second circumferential wall (50) present a closure mechanism (not shown) which keeps said walls (40, 50) closed.

In order to keep said mold assembled, it is necessary having a fastening mechanism (60), which comprises a first rod (61) and a second rod (62), a first pivoting lever (63) and a second pivoting lever (64); in such a way that a lower end of said first rod (61) or the second rod (62) is found fastened on the first or the second lower fastening site, respectively, on the lower lid (20), while an upper end of said first rod (61) or second rod (62) protrudes from the upper lid (10) at the first (14) or at the second (15) upper fastening sites, in such a way that the first (63) and second (64) pivoting levers, set on the first (14) and second (15) fastening sites for the lever, present a groove (65) which is coupled with the upper end which protrudes from the first (61) or from the second (62) rods and a knob (66) which allows the activation of said first (63) and second (64) pivoting levers.

Foams can be made using the cylindrical mold by injecting a foam forming composition into an orifice in the upper lid and allowing a foam-forming reaction to occur in the space between the hollow core and either the first interchangeable circumferential wall or the second interchangeable circumferential wall, depending on which interchangeable circumferential wall is set between the upper lid and the lower lid. For example, if a relatively thicker foam is desired, then first interchangeable circumferential wall is not set between the upper lid and the lower lid, whereas the second interchangeable circumferential wall is set between the upper lid and the lower lid and the foam is injected through the upper lid and into the space between the hollow core and the second interchangeable circumferential wall. The upper lid may be formed of a transparent plastic material (such as polycarbonate or polyurethane) so that foam formation can be observed through the upper lid. The foam can be easily removed from the mold for testing and evaluation by removing the upper lid and the second interchangeable circumferential wall by simply opening the second interchangeable circumferential wall with the handles and by releasing the closure mechanism.

On the other hand, if a foam having a lesser thickness is desired, then first interchangeable circumferential wall is set between the upper lid and the lower lid and the foam is injected through the upper lid into the space between the hollow core and the first interchangeable circumferential wall. Again, the upper lid may be formed of a transparent plastic material (such as polycarbonate or polyurethane) so that foam formation can be observed through the upper lid. The foam can be easily removed from the mold for testing and evaluation by removing the upper lid and the first interchangeable circumferential wall by simply opening the first interchangeable circumferential wall with the handles and by releasing the closure mechanism.

Another advantage of the mold of the invention is that temperature differences between a water heater core and the surrounding outer wall of the water heater can be simulated and tested by heating the hollow core, such as by placing it in an oven, and either heating or cooling the first interchangeable circumferential wall or the second interchangeable circumferential wall, such as by placing the wall in an oven or cooler, prior to injecting the foam.

Alterations to the structures and methods described in the present application may be foreseen by those persons skilled in the art. However, it must be understood that present description is described with the preferred embodiments of the invention, which are merely for illustrative purposes and must not be understood as a limitation to the invention. All embodiments which would be considered obvious within the spirit of the invention, such as changes in shape, material and sizes of the features which make up the invention, shall be considered as lying within the scope of the attached claims.

1. A cylindrical mold with a variable inner volume, the cylindrical mold comprising:
an upper lid;
a lower lid;
a first interchangeable circumferential wall and a second interchangeable circumferential wall, wherein at least one of said first and second interchangeable circumferential walls are set between said upper and lower lids;
a hollow core set in a concentric manner to said first and second interchangeable circumferential walls;
a closure for one of said first and second interchangeable circumferential walls; and
a fastening mechanism for at least one of said upper and lower lids, wherein said fastening mechanism is configure to keep the mold assembled.

2. The cylindrical mold of claim 1, wherein said upper and lower lids comprise a first and a second circumferential groove for coupling concentrically, wherein said first and second circumferential grooves are configured to be coupled to said first and second circumferential walls, respectively.

3. The cylindrical mold of claim 1, wherein the lower lid comprises a third circumferential groove for coupling concentrically, wherein said third circumferential groove is configured to be coupled to the hollow core.

4. The cylindrical mold of claim 3, wherein the third circumferential groove comprises a lesser radius than that of the first circumferential groove.

5. The cylindrical mold of claim 2, wherein the second circumferential wall comprises a greater radius than that of the first second circumferential wall, and wherein the radius of the first and of the second circumferential walls coincides with the radius of the first and the second circumferential grooves, respectively.

6. The cylindrical mold of claim 1, wherein said fastening mechanism comprises a first and a second rod, a first and a second pivoting lever, a knob on each pivoting lever, an upper and a lower fastening site for the rod and a fastening site for the pivoting lever; wherein a lower end of said first and second rods is fastened into the first and into the second lower fastening sites respectively on the lower lid, wherein an upper end of said first and second rods protrudes from the upper lid at the first and at the second upper fastening sites respectively, wherein said first and second pivoting levers, set on the first and on the second lever fastening sites respectively, comprise a groove which is coupled with the upper end which protrudes from the first and second rod and the knob allows for the activation of said first and second pivoting levers.

7. The cylindrical mold of claim 6, wherein said first and second pivoting levers are coupled to the upper lid.

8. The cylindrical mold of claim 1, wherein said first and second interchangeable circumferential walls are divided into a first and a second half cane section, wherein the first and second half cane sections are joined by a hinge mechanism at a first end.

9. The cylindrical mold of claim 8, wherein a second end of the first half cane section comprises a brow, which protrudes with a second end of the second half cane section when said first and second half cane sections are closed.

10. The cylindrical mold of claim 1, wherein the second interchangeable circumferential wall comprises a pair of diametrically opposite handles.

11. The cylindrical mold of claim 1, wherein the hollow core comprises a cylindrical body with an open lower end and a partially closed upper end, said partially closed upper end comprises a cavity from which a coiled rod is projected.

12. The cylindrical mold of claim 11, wherein the hollow core is fastened to the upper and lower lids by a coiled rod and is fastened by screws.

13. The cylindrical mold of claim 1, wherein the lower lid comprises a plurality of support legs equidistantly spaced.

14. The cylindrical mold of claim 1, wherein the upper lid comprises a foaming orifice and a plurality of vents.

15. A method of making a foam with the cylindrical mold of claim 1, comprising injecting a foam forming composition into an orifice in the upper lid and allowing a foam-forming reaction to occur in the space between the hollow core and either the first interchangeable circumferential wall or the second interchangeable circumferential wall.

16. The method of claim 15, wherein the first interchangeable circumferential wall is not set between the upper lid and the lower lid and the foam is injected through the upper lid and into the space between the hollow core and the second interchangeable circumferential wall.

17. The method of claim 16, further comprising removing the foam from the cylindrical mold by removing the upper lid and the second interchangeable circumferential wall.

18. The method of claim 15, wherein the first interchangeable circumferential wall is set between the upper lid and the lower lid and the foam is injected through the upper lid into the space between the hollow core and the first interchangeable circumferential wall.

19. The method of claim 18, further comprising removing the foam from the cylindrical mold by removing the upper lid and the first interchangeable circumferential wall.

20. The method of claim 15, further comprising heating the hollow core and either heating or cooling the first interchangeable circumferential wall or the second interchangeable circumferential wall prior to injecting the foam.
